(19) United States
(12) Patent Application Publication
(10) Pub. No.: US 2006/0180633 A1
(43) Pub. Date: Aug. 17, 2006

(54) Surgical staple

(75) Inventor: Clifford L. Emmons, Oakville, CT (US)

Correspondence Address: Mark Farber, Vice President Intellectual Property;TYCO Healthcare Group, LP, 150 Glover Avenue, Norwalk, CT, 06896, US

(73) Assignee: TYCO Healthcare Group, LP

(21) Appl. No.: 11/059,922

(22) Filed: Feb. 17, 2005

(51) Int. Cl. B31B 1/00

(52) U.S. Cl. 227/176.1

(57) ABSTRACT

A surgical staple is provided which includes a first leg having a distal end portion and a proximal end, a second leg having a distal end portion and a proximal end and a bridge member interconnecting the proximal ends of the first and second legs. In accordance with the present disclosure, the first leg has a first predetermined length and the second leg has a second predetermined length which is less than the first predetermined length of the first leg. The distal end portion of both the first leg and the second leg terminate in a distal angled surface, wherein the distal angled surface of the first leg and the distal angled surface of the second leg are oriented in the same direction as one another. The distal angled surface of the second leg is oriented toward the bridge member.

### BACKGROUND

1. Technical Field

The present disclosure relates to a surgical staple and, more particularly, to a leg configuration for a surgical staple in which the distal tips are oriented in the same direction as one another.

2. Background of Related Art

Surgical stapling apparatus are widely used in surgical procedures to fasten body tissue in a quick and efficient manner by driving fasteners or staples into the body tissue. In certain types of staplers, a single staple is typically formed against an anvil, e.g., skin staplers, for approximating body tissue.

In other types of staplers, such as those for mechanically stitching together hollow organs, a main linear drive (i.e., a cam member) moves longitudinally in a direction transverse to the direction that the staples are to be driven. Typically, such staplers employ a number of staple drive members or pusher elements which pass through grooved slots of a staple retaining cartridge, such slots being arranged end-to-end in rows. Under normal operation, the longitudinally moving cam member passes into and through the staple retaining cartridge, contacting cam surfaces on the drive members as the cam member passes through the grooved slots. Thus, the drive members convert linear motion from the cam member to transverse staple motion, thereby driving the row(s) of staples into the body tissue to be fastened.

An example of such an arrangement is described in commonly assigned U.S. Pat. No. 3,490,675 to Green et al. U.S. Pat. No. 3,490,675 generally discloses a drive member having a pusher plate, guide rails and a V-shaped portion for contacting the drive cam. A further modification is illustrated in commonly assigned U.S. Pat. No. 3,499,591 to Green. U.S. Pat. No. 3,499,591 discloses a two staple driver capable of driving double rows of staples in a single cam stroke for greater holding strength than a single row of staples.

Typically, as the surgical stapler is being fired (i.e., the staple driver is being advanced distally to expel the staples from a staple cartridge, through the body tissue and deform against a staple anvil) there is a flow of the body tissue, grasped between the staple cartridge and the staple anvil, in a distal direction.

Each of the above-described staple systems are commonly employed to drive conventional U-shaped staples having two opposed equal length legs terminating at one end in a sharpened skin or tissue-piercing point and connected at an opposite end by a linear bridge. When deformed, such staples tend to form a B-shape, wherein the legs are in a position to re-puncture the tissue being sutured. Typically, the tissue piercing points of the staples are oriented outwardly, i.e., the distal-most tip of each point is located along the inner surface of each leg and tapers outwardly therefrom to the outer surface of each leg. Further, since the legs of such staples have an equal length, as the stapler is fired, each leg of such staples will exit the staple pocket and will simultaneously meet the distal flow of body tissue. As is evident, the body tissue will continue to flow, in the distal direction, when passing the proximal-most leg of the staple due to the angled orientation of the tissue piercing point. Further, it is evident that the proximal most leg of each staple is unsupported along an inner surface thereof while the distal most leg of each staple is supported along the distal-most surface thereof by the distal wall of each staple pocket. Thus, as the staples are expelled from the staple pockets formed in the staple cartridge the distal flow of body tissue will cause the proximal-most leg of the staple to deflect in a distal direction.

Accordingly, it can be appreciated that there exists a continuing need for a new and improved surgical staple which reduces the amount of distal flow of body tissue that occurs, between the staple cartridge and the staple anvil, during a surgical stapling operation utilizing a surgical stapler.

### SUMMARY

The subject application is directed to a unique surgical staple which includes a first leg having a distal end portion and a proximal end, wherein the first leg has a first predetermined length, a second leg having a distal end portion and a proximal end, wherein the second leg has a second predetermined length which is less than the first predetermined length of the first leg and a bridge member interconnecting the proximal ends of the first and second legs.

In one preferred embodiment the distal end portion of the first leg terminates in a distal angled surface while the distal end portion of the second leg terminates in a distal angled surface. Preferably, the distal angled surface of the first leg and the distal angled surface of the second leg are oriented in the same direction as one another and more preferably, the distal angled surface of the second leg is oriented toward the bridge member. It is envisioned that the distal angled surface of the first leg can be oriented toward the bridge member.

The first leg and the second leg each define a respective longitudinal axis. Preferably, the distal angled surface of the first leg is angled from about 45° to about 55° relative to the longitudinal axis thereof and the distal angled surface of the second leg is angled from about 45° to about 55° relative to the longitudinal axis thereof.

In one embodiment, the surgical staple includes a bridge member defining a first distance and the distal angled surface of the first leg is spaced from the distal angled surface of the second leg a second distance. Preferably, the second distance is greater than the first distance.

In an alternative embodiment, the surgical staple includes a bridge member defining an axis. Accordingly, the longitudinal axis of the first leg is angled an amount which is less than about 90° relative to the axis defined by the bridge member and the longitudinal axis of the second leg is angled an amount which is less than about 90° relative to the axis defines by the bridge member.

It is contemplated that the first leg and the second leg lie in the same plane as one another. Preferably, the first leg and the bridge member define a first plane and the second leg and the bridge member define a second plane. In accordance with the present disclosure, it is contemplated that the second plane is angled an amount, about the axis defined by the bridge member, with respect to the first plane.

In accordance with an alternative embodiment of the present disclosure, the surgical staple includes a first leg having a distal end portion and a proximal end, wherein the distal end portion of the second leg terminates in an angled distal surface, a second leg having a distal end portion and a proximal end, wherein the distal end portion of the second leg terminates in an angled distal surface and a bridge member interconnecting the proximal ends of the first and second legs, wherein the distal angled surface of the first leg and the distal angled surface of the second leg are oriented in the same direction as one another.

These and other features of the surgical staple will become more readily apparent to those skilled in the art from the following detailed description of the subject application, the accompanying drawings and the claims.

### BRIEF DESCRIPTION OF THE DRAWINGS

The accompanying drawings, which are incorporated in and constitute a part of this specification, illustrate exemplary embodiments of the disclosure and, together with the general description given above, and the detailed description of the embodiments given below, serve to explain the principles of the present disclosure.

FIG. 1 is a front elevational view of a surgical staple in accordance with the principles of the present disclosure;

FIG. 2 is a side elevational view of the staple of FIG. 1;

FIG. 3 is an enlarged view of a distal end of a leg, indicated by area “3, of the staple shown in FIG. 1;

FIG. 4 is a cross-sectional schematic side elevational view of prior art staple being expelled from a distal end portion of a conventional surgical stapling apparatus;

FIG. 5 is an enlarged view of a prior art surgical staple being expelled from a conventional surgical stapling apparatus, as indicated by area “5 of FIG. 4;

FIG. 6 is a cross-sectional side elevational view of the surgical staple of FIG. 1 being expelled from a distal end portion of a conventional surgical stapling apparatus; and

FIG. 7 is an enlarged view of a surgical staple, in accordance with the principles of the present disclosure, being expelled from a conventional surgical stapling apparatus, as indicated by area “7 of FIG. 5.

### DETAILED DESCRIPTION OF PREFERRED EMBODIMIENTS

Preferred embodiments of the presently disclosed surgical stapler will now be described in detail with reference to the drawing figures wherein like reference numerals identify similar or identical elements. In the drawings, and in the description which follows, the term “proximal”, as is traditional, will refer to the end of the device or element which is closest to the operator, while the term “distal” will refer to the end of the device or element which is furthest from the operator.

It is envisioned that the surgical staples disclosed herein can be used with several known types of surgical staplers for various procedures (examples include: end-to-end anastomosis, “EEA™” circular end-to-end anastomosis, “CEEA™”; gastrointestinal anastomosis, “GIA™”; endoscopic gastrointestinal anastomosis, “Endo GIA™”; and transverse anastomosis, “TA™” staplers available from United States Surgical, a division of Tyco Health-Care Group, LP, Norwalk, Conn.) with each stapler including a staple anvil which is adjustably approximated relative a staple cartridge.

A typical staple cartridge generally has at least two laterally spaced rows of staple pockets having a staple disposed therein, while the staple anvil generally includes staple deforming depressions formed therein which staple deforming depressions are aligned with the rows of staple pockets in the cartridge. In use, each of the surgical staplers involves the gripping of body tissue to be fastened, the ejecting of individual staples, the forcing of staples through the gripped body tissue and the closing of the staples against the staple deforming depressions formed in the anvil of the stapler. While the following description will generally relate to a gastrointestinal anastomosis surgical stapler, it will be understood that the description of the surgical staple in accordance with the principles of the present disclosure can be applied to any of the aforementioned surgical staplers.

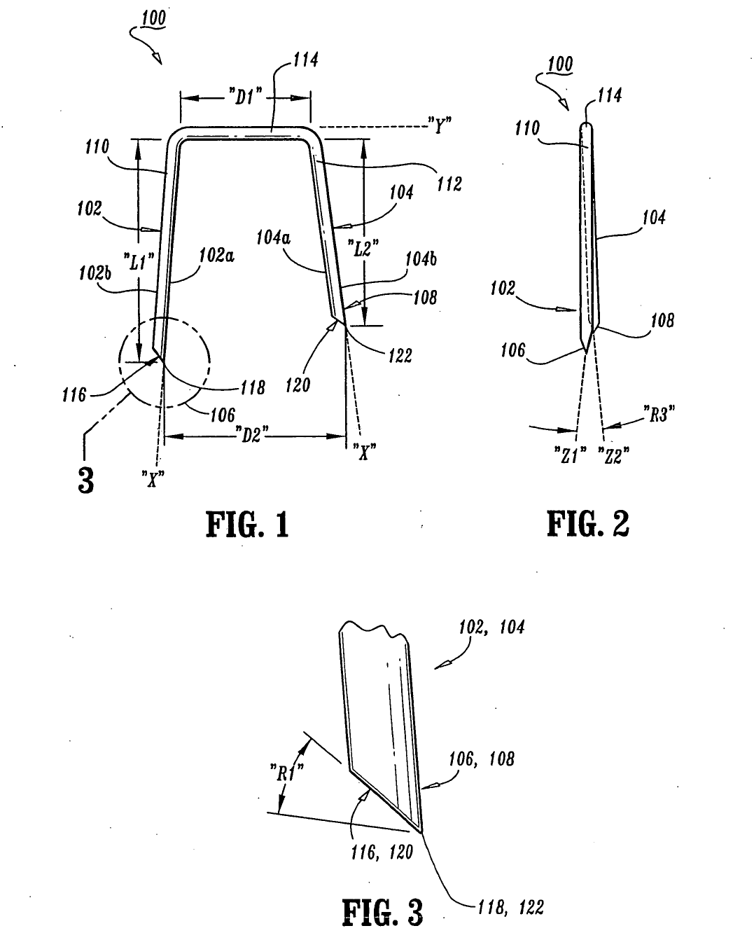

Referring now to FIGS. 1-3, a surgical staple, in accordance with the principles of the present disclosure, is shown generally as reference numeral 100. Staple 100 includes a first and a second leg 102 and 104, respectively, each terminating in a beveled distal end portion 106, 108, and interconnected at a proximal end 110, 112 thereof by a bridge portion 114. As shown in FIG. 1, first leg 102 has a length “L1” while second leg 104 has a length “L2”, wherein length “L1” is greater then length “L2”.

Preferably, in accordance with the present disclosure, beveled distal end portion 106 of first leg 102 is defined by a distal angled surface 116 terminating in a sharpened distal tip 118 while beveled distal end portion 108 of second leg 104 is defined by a distal angled surface 120 terminating in a sharpened distal tip 122. Preferably, distal angled surfaces 116 and 120 are oriented in the same direction. More preferably, distal angled surface 116 of first leg 102 is oriented in a direction away from bridge portion 114 while distal angled surface 120 of second leg 104 is oriented in a direction toward bridge portion 114.

Stated differently, first leg 102 defines an inner surface 102a oriented toward second leg 104 and an outer surface 102b defined by the side opposite inner surface 102a, while second leg 104 defines an inner surface 104a oriented toward first leg 102 and an outer surface 104b defined by the side opposite inner surface 104a. As such, in accordance with the present disclosure, distal angled surface 116 of first leg 102 is oriented toward outer surface 102b while distal angled surface 120 of second leg 104 is oriented toward inner surface 104a. Preferably, distal angled surface 120 of second leg 104 is angled in a direction opposite to distal angled surface 116 of first leg 102.

As shown in FIG. 1 and in greater detail in FIG. 3, distal angled surfaces 116, 120 are angled an amount “R1” relative to a longitudinal axis of each leg 102, 104. Preferably, distal angled surfaces 116, 120 are angled an amount “R1” ranging from about 45° to about 55° relative to the longitudinal axis. While an angular amount “R1” ranging from about 45° to about 55° relative to the longitudinal axis is preferred, it is envisioned that different angular orientations of distal angled surfaces 116, 120 are possible.

While it is preferred that distal angled surfaces 116, 120 are oriented in the same direction, it is envisioned that while distal angled surface 120 of second leg 104 is oriented toward bridge portion 114, distal angled surface 116 of first leg 102 can be oriented in any number of directions including oriented toward bridge portion 114.

Returning to FIG. 1, it is seen that first leg 102 and second leg 104 diverge from one another. In other words, proximal ends 110, 112 are spaced a distance “D1” from one another while distal end portions 106, 108 are spaced a distance “D2” from one another, wherein distance “D2” is greater than distance “D1”. Preferably, distance “D1” ranges from about 0.116 to about 0.119 inches while distance “D2” ranges from about 0.145 to about 0.165 inches. Stated differently, bridge portion 114 defines a bridge axis “Y” while first and second legs 102, 104 each define a longitudinal axis “X” wherein longitudinal axes “X” are angled an amount “R2” relative to an axis which is orthogonal to the “Y” axis. Accordingly, the longitudinal “X” axis of each leg 102, 104 is angled an amount “R2” which is less than about 90°.

Referring now to FIG. 2, is it seen that first leg 102 and bridge 114 define a first plane “Z1” while second leg 104 and bridge portion 114 define a second plane “Z2”, angled an amount “R3” relative to one another. Preferably, first plane “Z1” and second plane “Z2” are angled an amount “R3” which offsets distal end portion 106 and distal end portion 108 from one another by an amount equal to about 0.006 inches in a direction orthogonal to first plane “Z1”. In this manner, as first and second legs 102, 104 are deformed during a staple forming process, distal end portions 106, 108 will be out of plane with respect to one another, thus not interfering with one another.

It is envisioned that surgical staple 100 may be formed from a medical grade material wire, such as for example, stainless steel, titanium, or other similar material suitable for surgical utilization. Preferably, surgical staple has a cross-section which is substantially circular. Alternatively, surgical staple 100 can be formed from a wire having a substantially oval, rectangular, semi-circular or other cross-sectional configuration which can be utilized to construct staples.

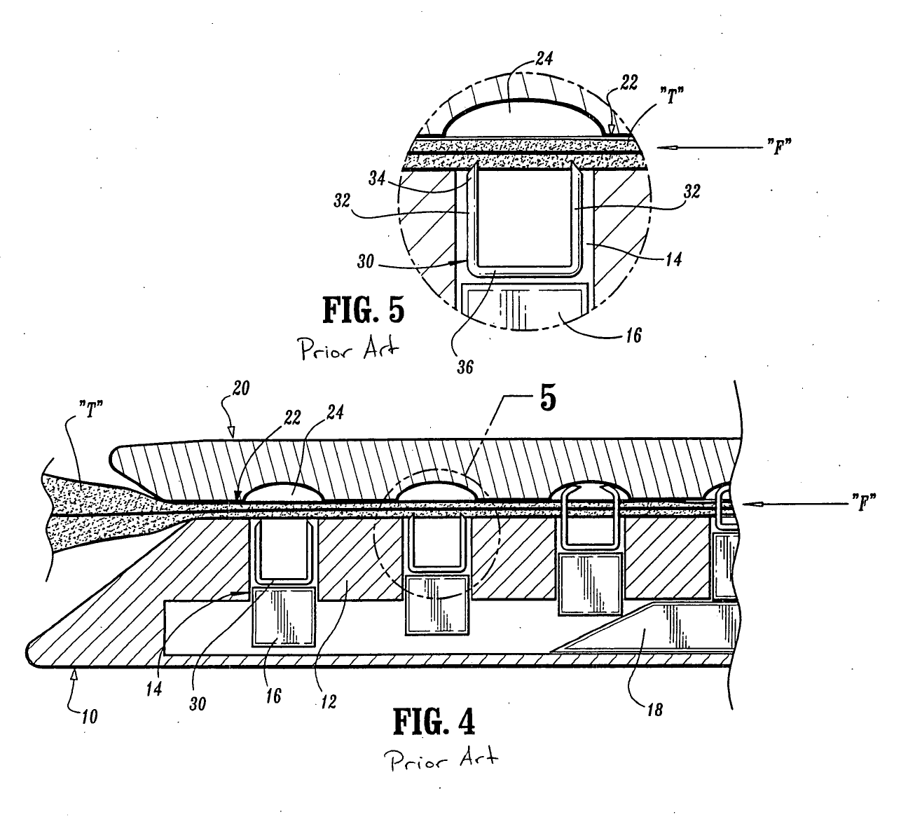

Turning now to FIGS. 4 and 5, a cross-sectional schematic side elevational view of prior art surgical staples being expelled from a distal portion of a conventional surgical stapling apparatus is shown. As seen in FIG. 4, the distal portion of the conventional surgical stapling apparatus includes a first jaw 10 defining a staple cartridge 12 having a plurality of elongated slots 14 for storing conventional staples 30 therein and a staple drive member 18 slidably extending therethrough. Drive member 18 being configured and adapted to transform a linear movement thereof into a transverse movement of a pusher 16 disposed in each elongated slot for transversely expelling conventional staples 30 therefrom. The distal portion of the conventional surgical stapling apparatus further includes a second jaw 20 having an anvil 22 provided on the inner surface thereof and includes a plurality of anvil pockets 24, aligned with slots 14, configured and adapted to deform the legs of staples 30. First and second jaws 10, 20 are pivotably mounted to one another in order to clamp body tissue “T” between staple cartridge 12 and anvil 22.

Conventional staples 30 include a pair of opposed legs 32 terminating at one end in a sharpened distal tip 34 and connected at an opposite end by a bridge member 36. As seen in FIGS. 4 and 5, each leg 32 of conventional staples 30 has a length which is equal to one another. Moreover, legs 32 of conventional staples 30 are parallel to one another and are substantially orthogonal to bridge member 36.

In use, with body tissue “T” clamped between staple cartridge 12 and anvil 22, as drive member 18 is advanced distally through staple cartridge 12, drive member 18 forces each pusher 16 in a transverse direction through slots 14 and ultimately staples 30 out of slots 14 and into body tissue “T”. As staples 30 are expelled and formed, from a proximal end of the stapling apparatus toward a distal end of the stapling apparatus, there is a flow “F” of body tissue “T” in a distal direction. Accordingly, since legs 32 of each staple 30 have an equal length they are simultaneously expelled from slots 14. As seen in detail in FIG. 5, when distal tip 34 of legs 32 meet distal flow “F” of body tissue “T”, the distal most leg remains upright, since the distal most leg is supported along a distal side thereof (i.e., supported by the inner wall of slot 14), while the proximal most leg tends to deflect in a distal direction since the proximal most leg is not supported along a distal side thereof. Moreover, as seen in FIG. 5, since distal tips 34 are angled outwardly (i.e., the longer portion of the legs is located inside of the shorter portion) body tissue “T” will tend to ride up and over the angled surface of the proximal most leg thus permitting the continued flow “F” of body tissue “T”.

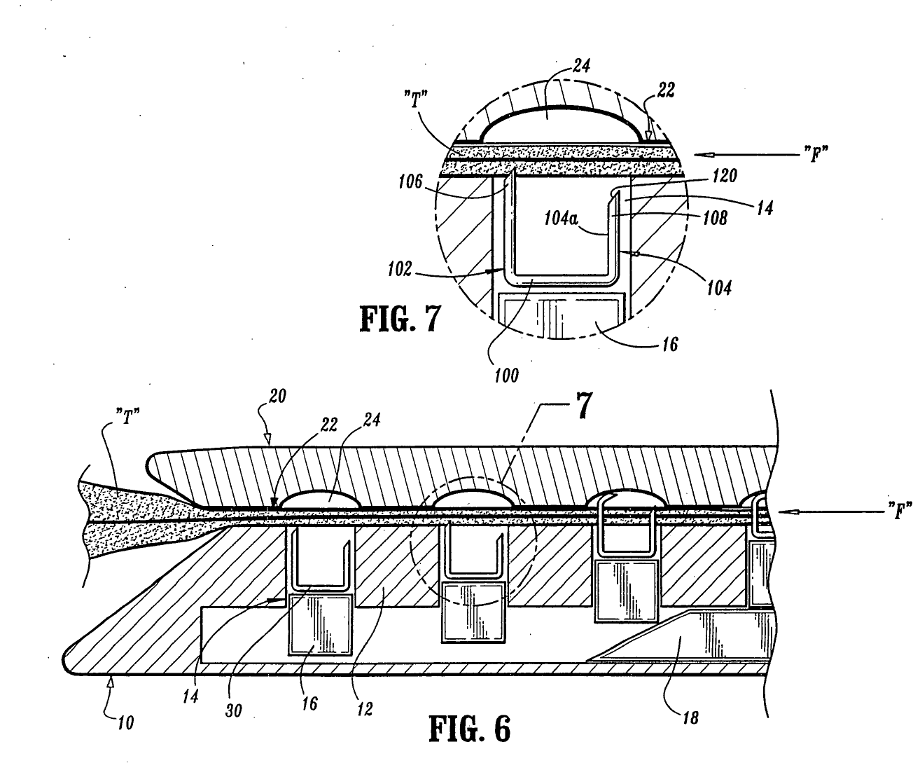

Turning now to FIGS. 6 and 7, a cross-sectional schematic side elevational view of surgical staples 100, in accordance with the principles of the present disclosure, are being expelled from a distal portion of a conventional surgical stapling apparatus, as described above, is shown. As seen in FIG. 4, surgical staples 100 are deliberately placed within slots 14 of staple cartridge 12 such that first leg 102 is positioned distally of second leg 104. In particular, surgical staples 100 are placed within slots 14 such that the longer leg (i.e., leg 102) is located in the distal portion slot 14 while the shorter leg (i.e., leg 104) is located in the proximal portion of slot 14.

In use, as seen in FIG. 6 and in greater detail in FIG. 7, with body tissue “T” clamped between staple cartridge 12 and anvil 22, as drive member 18 is advanced distally through staple cartridge 12, drive member 18 forces each pusher 16 in a transverse direction through slots 14 and ultimately staples 100 out of slots 14 and into body tissue “T”. Since staples 100 have uneven legs 102, 104 and since longer leg 102 is located distally of shorter leg 104, as staples 100 are expelled from slots 14, longer legs 102 will project out of staple cartridge 12 before shorter legs 104. As such, distal end portion 106 of legs 102 will penetrate body tissue “T” before distal end portion 108 of legs 104. Moreover, distal end portion 106 of legs 102 will meet distal flow “F” of body tissue “T” before distal end portion 108 of legs 104.

As seen in detail in FIG. 7, when distal end portion 106 of legs 102 meet distal flow “F” of body tissue “T”, legs 102 remain upright since they are supported along outer surface 102B thereof by the inner wall of slot 14. In addition, legs 102 interfere with and slow down the rate of distal flow “F” of body tissue “T” in effect causing body tissue “T” to “back-up” so that when distal end portion 108 of legs 104 penetrate body tissue “T” they will not be deflected in a distal direction when passing through body tissue “T”.

Moreover, as seen in FIG. 7, since distal angled surface 120 of second leg 104 of staples 100 are preferably angled to face inner surface 104a of second leg 104, the effect of body tissue “T” riding up and over distal end portion 108 of second leg 104 is reduced in present staple 100 as compared to conventional staples 30.

It will be understood that various modifications may be made to the embodiments disclosed herein. Therefore, the above description should not be construed as limiting, but merely as exemplifications of preferred embodiments. For example, the subject invention, which has been described with respect to a surgical apparatus wherein the staples are fired transverse to the longitudinal axis, may alternatively be described with respect to an apparatus wherein the staples are driven longitudinally against an anvil having a staple forming surface extending transversely and disposed opposite the staples. Those skilled in the art will envision other modifications within the scope and spirit of the claims appended hereto.

What is claimed is:

1. A surgical staple, comprising:
a first leg having a distal end portion and a proximal end, wherein the first leg has a first predetermined length;
a second leg having a distal end portion and a proximal end, wherein the second leg has a second predetermined length which is less than the first predetermined length of the first leg; and
a bridge member interconnecting the proximal ends of the first and second legs.

2. The surgical staple according to claim 1, wherein the distal end portion of the first leg terminates in a distal angled surface and wherein the distal end portion of the second leg terminates in a distal angled surface.

3. The surgical staple according to claim 2, wherein the distal angled surface of the first leg and the distal angled surface of the second leg are oriented in the same direction as one another.

4. The surgical staple according to claim 2, wherein the distal angled surface of the second leg is oriented toward the bridge member.

5. The surgical staple according to claim 4, wherein the distal angled surface of the first leg is oriented toward the bridge member.

6. The surgical staple according to claim 5, wherein the first leg and the second leg each define a respective longitudinal axis, wherein the distal angled surface of the first leg is angled from about 45° to about 55° relative to the longitudinal axis thereof and wherein the distal angled surface of the second leg is angled from about 45° to about 55° relative to the longitudinal axis thereof.

7. The surgical staple according to claim 6, wherein the bridge member defines a distance and wherein the distal angled surface of the first leg is spaced a distance from the distal angled surface of the second leg which distance between the distal angled surfaces of the first and second legs is greater than the distance defined by the bridge member.

8. The surgical staple according to claim 6, wherein the bridge member defines an axis and wherein the longitudinal axis of the first leg is angled an amount which is less than about 90° relative to the axis defined by the bridge member and wherein the longitudinal axis of the second leg is angled an amount which is less than about 90° relative to the axis defines by the bridge member.

9. The surgical staple according to claim 8, wherein the first leg lies in the same plane as the second leg.

10. The surgical staple according to claim 8, wherein the first leg and the bridge member define a first plane and wherein the second leg and the bridge member define a second plane which is angled with respect to the first plane about the axis defined by the bridge member.

11. The surgical staple according to claim 1, wherein the staple is formed of a material selected from the group consisting of titanium and stainless steel.

12. A surgical staple, comprising:
a first leg having a distal end portion and a proximal end, wherein the distal end portion of the second leg terminates in an angled distal surface;
a second leg having a distal end portion and a proximal end, wherein the distal end portion of the second leg terminates in an angled distal surface; and
a bridge member interconnecting the proximal ends of the first and second legs, wherein the distal angled surface of the first leg and the distal angled surface of the second leg are oriented in the same direction as one another.

13. The surgical staple according to claim 12, wherein the first leg has a first predetermined length and wherein the second leg has a second predetermined length which is less than the first predetermined length of the first leg.

14. The surgical staple according to claim 13, wherein the distal angled surface of the first leg and the distal angled surface of the second leg are oriented in the same direction.

15. The surgical staple according to claim 14, wherein the distal angled surface of the second leg is oriented toward the bridge member.

16. The surgical staple according to claim 15, wherein the first leg and the second leg each define a respective longitudinal axis, wherein the distal angled surface of the first leg is angled from about 45° to about 55° relative to the longitudinal axis thereof and wherein the distal angled surface of the second leg is angled from about 45° to about 55° relative to the longitudinal axis thereof.

17. The surgical staple according to claim 16, wherein the bridge member defines a distance and wherein the distal angled surface of the first leg is spaced a distance from the distal angled surface of the second leg which distance between the distal angled surfaces of the first and second legs is greater than the distance defined by the bridge member.

18. The surgical staple according to claim 16, wherein the bridge member defines an axis and wherein the longitudinal axis of the first leg is angled an amount which is less than about 90° relative to the axis defined by the bridge member and wherein the longitudinal axis of the second leg is angled an amount which is less than about 90° relative to the axis defines by the bridge member.

19. The surgical staple according to claim 18, wherein the first leg lies in the same plane as the second leg.

20. The surgical staple according to claim 18, wherein the first leg and the bridge member define a first plane and wherein the second leg and the bridge member define a second plane which is angled with respect to the first plane about the axis defined by the bridge member.

21. A surgical staple for use in a surgical stapling apparatus, wherein the surgical stapling apparatus includes a staple cartridge having a plurality of elongated slots for storing the surgical staples therein, and an anvil operatively associated with the staple cartridge and including a plurality of anvil pockets configured and adapted to deform the legs of staples as the legs of the staples impinge thereagainst, the surgical staple comprising:
a first leg having a distal end portion and a proximal end, wherein the first leg has a first predetermined length;
a second leg having a distal end portion and a proximal end, wherein the second leg has a second predetermined length which is less than the first predetermined length of the first leg; and
a bridge member interconnecting the proximal ends of the first and second legs, wherein the staples are oriented in the slots of the staple cartridge such that the first leg is located distally of the second leg.

22. The surgical staple according to claim 21, wherein the distal end portion of the first leg terminates in a distal angled surface and wherein the distal end portion of the second leg terminates in a distal angled surface.

23. The surgical staple according to claim 22, wherein the distal angled surface of the first leg and the distal angled surface of the second leg are oriented in the same direction.

24. The surgical staple according to claim 23, wherein the distal angled surface of the second leg is oriented toward the bridge member.
